(19) United States
(12) Patent Application Publication
(10) Pub. No.: US 2025/0148717 A1
(43) Pub. Date: May 8, 2025

(54) AUTOMATIC RIGGING OF THREE-DIMENSIONAL (3D) OBJECTS

(71) Applicant: Roblox Corporation, San Mateo, CA (US)

(72) Inventors: Sheldon Paul ANDREWS, Hudson (CA); Maneesh AGRAWALA, San Mateo, CA (US); Hsueh-Ti Derek LIU, Burnaby (CA)

(73) Assignee: Roblox Corporation, San Mateo, CA (US)

(21) Appl. No.: 18/939,411

(22) Filed: Nov. 6, 2024

Related U.S. Application Data
(60) Provisional application No. 63/547,662, filed on Nov. 7, 2023.

(51) Int. Cl. G06T 17/20; G06T 13/20

(52) U.S. Cl. CPC G06T 17/20; G06T 13/20

(57) ABSTRACT

Implementations relate to methods, systems, and computer-readable media to automatically perform rigging of physics-based three-dimensional objects. In some implementations, the method may include obtaining a 3D mesh of a 3D object, segmenting the 3D mesh into two or more sub-meshes, wherein each sub-mesh corresponds to a respective part of the 3D object, determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object, and calculating a plurality of parameters for the constraint graph based on one or more objective functions, wherein the sub-meshes, the constraint graph, and the plurality of parameters are usable to simulate motion of the 3D object in a virtual environment.

### CROSS-REFERENCE TO RELATED APPLICATIONS

This application claims priority to U.S. Provisional Application No. 63/547,662, entitled “AUTOMATIC RIGGING OF PHYSICS-BASED ASSETS,” filed on Nov. 7, 2023, the content of which is incorporated herein in its entirety.

### TECHNICAL FIELD

Embodiments relate generally to computer-based virtual experiences and computer graphics, and more particularly, to methods, systems, and computer readable media to automatically perform rigging of physics-based three-dimensional (3D) object assets that are rendered on computing devices.

### BACKGROUND

Some online virtual experience platforms allow users to connect with each other, interact with each other (e.g., within a virtual experience), create virtual experiences, and share information with each other via the Internet. Users of online virtual experience platforms may participate in multiplayer environments (e.g., in virtual three-dimensional environments), design custom environments, design characters, three-dimensional (3D) objects, and avatars, decorate avatars, and exchange virtual items/objects with other users.

One of the challenges in computer graphics is the rigging of physics-based 3D objects such as vehicles in virtual environments. Rigging is performed to enable simulation of the 3D object, and to recreate realistic motion of the 3D object, as governed by the laws of physics. Content creators (developers) may start with a 3D mesh of a 3D object created or designed according to a particular intent, which has to subsequently be suitably rigged in order to be utilized with a physics engine that can be applied to a model of the 3D object during simulation. Rigging may include identifying rigid bodies that approximate parts of the 3D object, as well as joints and constraints, in addition to determining suitable values for parameters associated with the constraints.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform a method that includes obtaining a three-dimensional (3D) mesh of a 3D object, segmenting the 3D mesh into two or more sub-meshes, wherein each sub-mesh corresponds to a respective part of the 3D object, determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object, and calculating a plurality of parameters for the constraint graph based on one or more objective functions, wherein the sub-meshes, the constraint graph, and the plurality of parameters are usable to simulate motion of the 3D object in a virtual environment.

In some implementations, the computer-implemented method may further include determining the constraint graph for the 3D object using the transformer model comprises providing the two or more sub-meshes as a sequence of tokens to the transformer model, wherein the sequence of tokens is mapped by the transformer model to the constraint graph for the 3D object.

In some implementations, calculating the plurality of parameters for the constraint graph comprises determining values for one or more parameters associated with the set of joints based on user-specified criteria. In some implementations, determining the values for the one or more parameters associated with the set of joints comprises performing an optimization of the one or more objective functions that encode the user-specified criteria.

In some implementations, the computer-implemented method may further include receiving the user-specified criteria from a user and determining a respective type of the one or parameters based on the user-specified criteria.

In some implementations, segmenting the 3D mesh into the two or more sub-meshes comprises applying a trained classifier to the 3D mesh of the 3D object. In some implementations, the computer-implemented method may further include training the classifier model, wherein the training comprises training the classifier on a training dataset that includes 3D meshes of 3D objects and sub-meshes corresponding to the 3D meshes.

In some implementations, the computer-implemented method may further include training the transformer model with an augmented training dataset, wherein the augmented training dataset includes sequences of segmented labeled parts of 3D meshes of parts of 3D objects included in the training dataset.

In some implementations, the computer-implemented method may include segmenting the 3D mesh into the two or more sub-meshes comprises applying a trained regression model to the 3D mesh of the 3D object.

In some implementations, the computer-implemented method may further include simulating motion of the 3D object in the virtual environment by providing to a physics solver a current state of the 3D object, the constraint graph, the plurality of parameters, and one or more forces acting on the 3D object in the virtual environment, wherein the physics solver determines an updated state of the 3D object; and displaying the 3D object in the virtual environment based on the updated state.

One general aspect includes a non-transitory computer-readable medium with instructions stored thereon that when executed, performs operations that include obtaining a three-dimensional (3D) mesh of a 3D object, segmenting the 3D mesh into two or more sub-meshes, wherein each sub-mesh corresponds to a respective part of the 3D object, determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object, and calculating a plurality of parameters for the constraint graph based on one or more objective functions, wherein the sub-meshes, the constraint graph, and the plurality of parameters are usable to simulate motion of the 3D object in a virtual environment.

One general aspect includes a system that includes a memory with instructions stored thereon; and a processing device coupled to the memory, the processing device configured to access the memory and execute the instructions, where the execution of the instructions cause the processing device to perform operations that may include obtaining a three-dimensional (3D) mesh of a 3D object, segmenting the 3D mesh into two or more sub-meshes, wherein each sub-mesh corresponds to a respective part of the 3D object, determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object, and calculating a plurality of parameters for the constraint graph based on one or more objective functions, wherein the sub-meshes, the constraint graph, and the plurality of parameters are usable to simulate motion of the 3D object in a virtual environment.

### BRIEF DESCRIPTION OF THE DRAWINGS

FIG. 1 is a diagram of an example environment to perform automatic rigging of physics-based three-dimensional (3D) object assets rendered on a computing device, in accordance with some implementations.

FIG. 2 depicts an example of an end-to-end workflow to perform automatic rigging of physics-based three-dimensional (3D) objects, in accordance with some implementations.

FIG. 3 illustrates an example method to perform automatic rigging of a three-dimensional (3D) object, in accordance with some implementations.

FIG. 4 illustrates an example of applying a classifier model to a 3D object to determine sub-meshes, in accordance with some implementations.

FIG. 5 illustrates an example of a constraint graph determined for a 3D object based on a set of sub-meshes, in accordance with some implementations.

FIG. 6A depicts an example of tuning of constraint parameters for a 3D object, in accordance with some implementations.

FIG. 6B depicts an example of a 3D object with optimized constraint graph parameters, in accordance with some implementations.

FIG. 7 illustrates an end-to-end workflow to perform automatic rigging of physics-based three-dimensional (3D) objects, in accordance with some implementations.

FIG. 8 depicts an example training of a classifier model to determine one or more sub-meshes from a mesh of a 3D object, in accordance with some implementations.

FIG. 9 depicts an example sequence of sub-meshes and a corresponding target constraint graph utilized in training a transformer model, in accordance with some implementations.

FIG. 10 illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some embodiments”, “an embodiment”, “an example embodiment”, etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

Online virtual experience platforms (also referred to as “user-generated content platforms” or “user-generated content systems”) offer a variety of ways for users to interact with one another. For example, users of an online virtual experience platform may work together towards a common goal, share various virtual experience items, send electronic messages to one another, and so forth. Users of an online virtual experience platform may join virtual experience(s), e.g., games or other experiences as virtual characters, playing specific roles. For example, a virtual character may be part of a team or multiplayer environment wherein each character is assigned a certain role and has associated parameters, e.g., clothing, armor, weaponry, skills, etc. that correspond to the role. In another example, a virtual character may be joined by computer-generated characters, e.g., when a single player is part of a game.

A virtual experience platform may enable users (developers) of the platform to create objects, new games, and/or characters. For example, users of the online gaming platform may be enabled to create, design, and/or customize new characters (avatars), new animation packages, new three-dimensional objects, etc. and make them available to other users.

On some virtual platforms, developer users may upload three-dimensional (3D) object models, e.g., meshes and/or textures of 3D objects, for use in a virtual experience and for trade, barter, or sale on an online marketplace. The models may be utilized and/or modified by other users. The model can include 3D meshes that represent the geometry of the object and include vertices, and define edges, and faces. The model may additionally include textures that define the object surface.

The virtual experience platform may support use of virtual objects that mimic physical objects (rigid body three dimensional (3D) objects) within a virtual environment. For example, the virtual experience platform may enable users to design and introduce various categories of virtual 3D objects, e.g., vehicles, weapons and weapon accessories, toys, structures, etc. These objects may be viewed by one or more users within a virtual environment supported by the virtual experience platform. For example, motion of such 3D objects within the virtual environment may be displayed on user devices.

Simulation may be performed to determine a current state of a 3D object based on properties of the 3D object, a previous state, and various force(s) acting on the object. Simulation may be performed using a physics engine (physics platform or physics solver), which is utilized to apply various physical laws to rigged 3D objects within a virtual environment.

The process of rigging involves associating the geometry of a polygonal mesh or implicit surface to be driven by an underlying structure. This conveys the effect of deformation and/or motion of a 3D object based on the motion of the underlying structure.

Rigging of 3D objects such as characters (avatars) can utilize standardized rigs (skeletons), e.g., R6 based virtual characters (with 6 joints), R15 based virtual characters (with 15 joints), etc., that are fitted to a surface geometry of an avatar to provide an underlying structure. In some implementations, the rigging of the avatar may be performed automatically. An objective of rigging of avatars is to generate aesthetically pleasing geometric deformations of the avatar based on the motion of the skeleton.

Rigging in organic 3D objects such as avatars, e.g., humanoids, animals, birds etc., is based on an underlying skeletal structure. However, rigging for mechanical 3D objects that are physics-based, e.g., vehicles, mechanisms, etc., can be a complex task due to the absence of a common underlying structure. For example, vehicles can include multiple types of doors, different suspension systems, wheels, etc. Additionally, the parts of the vehicle can be interconnected in multiple ways, and with different types of joints.

Automating the rigging of 3D objects such as vehicles, mechanisms, airplanes, etc., pose additional challenges. Unlike the rigging of characters, rigging of physics-based assets involves assigning a set of joints and physics-based rigid bodies that drive the motion of the surface geometry.

Unlike the movement of characters (e.g., that have deformable bodies), motion of 3D objects is associated with rigid motion of multiple rigid bodies and/or joints rather than a deformation resulting from smooth blending of 3D transformations of an underlying skeleton. Additionally, the simulation of self-collision and contact is generally not needed during the rigging of characters.

With physics-based rigging, the deformation of the 3D object as it gets acted upon by forces can produce collisions between the various components of the rigged 3D object, as well as between the rig and the environment.

A technical objective in rigging of physics-based 3D objects is to associate a 3D geometry with an underlying physics-based model and to automatically tune model parameters such that it produces a specific behavior or performs a particular function during the physics simulation.

A challenge in computer graphics and virtual experience (e.g., game) design, is the process of rigging a mesh of a 3D object, particularly of 3D objects that are rigid bodies, assemblies, and/or mechanisms. In many scenarios, content creators (developers) may start with a mesh of a 3D object that accurately represents the surface features of the 3D object, e.g., outer geometry of the 3D object, texture of the 3D object, etc. However, applying a physics solver directly to the 3D mesh during a virtual experience, e.g., a game where a vehicle is moving, may lead to unrealistic simulation of the 3D object since the surface geometry alone may not be representative of physics properties of the 3D object. For example, a 3D mesh of a car may not include accurate representation of the wheels of the car in that the wheels of the car when connected to an axle of the car roll on a surface, and thereby experience lower frictional forces when compared to other types of geometries, e.g., flat surfaces, that may experience higher frictional forces.

Accurate rigging of a 3D object is needed for accurate simulation of the 3D object, when subjected to external and/or internal forces. However, the rigging process can be time-consuming and arduous, requiring manual work, thereby impeding the ability of the developer to efficiently rig a mesh.

Per techniques of this disclosure, physics rigging is automatically performed to generate physics models of 3D objects based on 3D meshes of the 3D object. The rigging process includes multiple stages whereby a physics model of a 3D object (e.g., a model of the 3D mesh of a 3D object that is compatible with a physics solver) can be generated from a 3D mesh of the 3D object that includes only a surface representation of the 3D object.

As an example, rigging of a vehicle, e.g., a car, is described herein. A 3D model, e.g., a polygon mesh, of a car is obtained. The polygon mesh is segmented into respective sub-meshes that correspond to different parts of the car. Individual components of the car are segmented into a discrete, closed sub-mesh. For example, the geometry of each wheel of the car must be independent of each other, and independent from the geometry that makes up the chassis of the car. Effectively, individual components are segmented into a sub-mesh.

Subsequent to segmenting the 3D mesh into sub-meshes, corresponding collision geometry is generated that can be utilized to simulate behavior of the 3D object when the 3D object undergoes collisions, e.g., with other 3D objects and/or surfaces in the virtual environment.

In some implementations, collision primitives such as convex meshes, and/or simple parametric shapes such as cylinders, spheres, boxes, etc., that approximate the shape(s) of the parts of the 3D object may be utilized to simulate the collisions. It may be beneficial to utilize simplified geometries for collision testing since the tests can be performed more efficiently when compared to performing the tests with original geometries. However, in some implementations, the segmented sub-meshes may be directly utilized for collision simulation. The mass of components may be automatically computed from the geometry and utilized in the simulation.

In some implementations, the position and/or size of the components (parts) is adjusted. In some implementations, a relative position and orientation of individual components is determined in order to obtain a good approximation of the surface geometry by the collision geometry.

In some implementations, additional collision detection rules may be specified to avoid generating contacts when particular components intersect, e.g., if the initial configuration of the particular components itself has the components in contact.

In addition to segmenting a mesh into respective sub-meshes that correspond to different parts, constraints associated with the sub-meshes are defined. For example, constraints are utilized to model joints, which couple the relative motion of components. For example, a prismatic joint may be utilized to model relative sliding motion between two components, Similarly, a hinge may be utilized to model the relative rotation of a component about a single axis. Determining the type of constraint has an effect on an overall behavior of the physics-based 3D object asset.

In some implementations, the relative position and orientation of joints are tuned in order to obtain a specific physical behavior for the 3D object. For example, when rigging a car, the spring constraints attaching the wheels of the car to the chassis (body) are tuned in order to replicate the behavior of a vehicle suspension.

In some implementations, additional operations are performed to tune material parameters of components of the 3D object, e.g., the stiffness of joints, damping, mass distribution, etc.

Subsequent to the configuration of the geometry, mass, and constraints of different components in the 3D object, the physics-based 3D object asset, e.g., a car, made up of the components is simulated. The behavior of the 3D object may be evaluated to determine whether it matches specified requirements. The operations outlined above may be repeated if the behavior of the 3D object does not match the specified requirements.

Rigging via human intervention requires specialized knowledge about geometry processing, 3D modeling, and physics-based simulation. This can present a challenge to novice users, and even experienced users may be required to perform multiple iterations of the rigging in order to achieve a target physical behavior of the 3D object. The automatic pipeline described herein can enable a larger set of developer users (including those with limited or no skills in rigging) to create physics-based assets.

An objective of a virtual experience platform provider is the provision of realistic depiction of 3D objects, and particularly the physical behavior of 3D objects. An additional objective is to provide tools to content creators that can enable them to perform rigging of 3D objects.

A technical problem is the provision of automatic, accurate, scalable, cost-effective, and reliable tools for creation (generation) and editing of 3D objects.

Techniques described herein may be utilized to provide a scalable and adaptive technical solution for the physical rigging of 3D objects. In some implementations, an automatic rigging pipeline may include a first stage that accepts as input an arbitrary mesh or geometry representing the physics-based asset to be rigged. The first stage may include a part segmentation and/or labeling operation that is followed by a second stage where a plurality of constraints that couple motion between the parts are inferred. Subsequently, a numerical optimization is performed to fine tune model parameters by utilizing a physics-in-the-loop optimization.

In some implementations, the techniques may be utilized within a tool, e.g., a studio tool that may be utilized by developers to rig mesh assets that have been generated based on descriptions, e.g., textual prompts, voice prompts, sketches, etc. In some implementations, the tool may support creators to create physics-based 3D objects, e.g., for 3D objects where the 3D models (e.g., 3D meshes) have been created by the user, as well as for 3D models (3D meshes) provided via the virtual experience platform, 3D meshes obtained or purchased from other users, etc.

In some implementations, the techniques described herein may be utilized by a virtual experience platform to enable users to modify properties of a 3D object, during their participation in a virtual experience, thereby enabling creators and players to customize 3D objects based on their preferences. This can enable in-experience creation wherein users (e.g., non-developer users) can utilize the techniques to customize 3D objects for their virtual experience.

In some implementations, iterative refinement of the geometry of a 3D object may be performed based on modified descriptors, e.g., text prompts, received from a user. For example, in scenarios where the initial generation of the rigged 3D object does not meet a user's expectation, iterative refinement may be utilized to provide additional mesh geometry customization via an interactive approach. During this iterative process, users can provide text prompts, e.g., to introduce additional descriptions for the 3D object and its physics. This may enable the users to steer the creative direction and achieve a satisfactory result for physics-based 3D objects.

In some implementations, support may be provided for multiple types of input modalities from a user. For example, there may be scenarios where some portions of the geometry may be rigged (designed) by the user, whereas a remainder of the portions of the geometry may be automatically rigged using the techniques described herein. For example, a type of joint may be specified by a user while the parameters of the joint may be automatically determined.

Techniques for mesh rigging described herein introduce a new approach to the rigging of physics-based 3D objects that can enable users to create a wide variety of 3D objects. The automated processes contribute to more efficient and accessible 3D mesh customization, promoting creativity and enabling a wider range of users to create physics-based 3D objects with case.

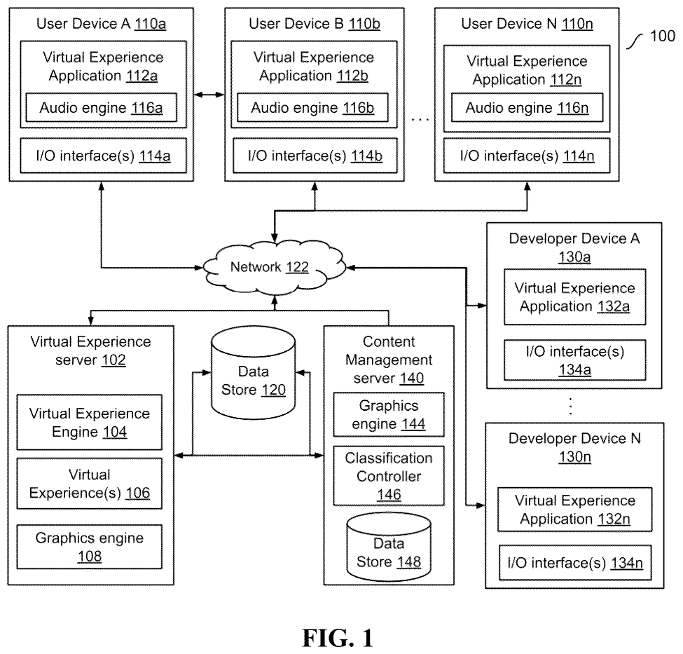

FIG. 1 is a diagram of an example environment to perform automatic rigging of physics-based three-dimensional (3D) object assets that are rendered on a computing device, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, user devices 110a, 110b, and 110n (generally referred to as “user device(s) 110” herein), and developer devices 130a and 130n (generally referred to as “developer device(s) 130” herein), virtual experience server 102, content management server 140, data store 120, user devices 110, and developer devices 130 are coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Content management server 140 can include a graphics engine 144, and a classification controller 146. In some implementations, the content management server may include a plurality of servers. In some implementations, the plurality of servers may be arranged in a hierarchy, e.g., based on respective prioritization values assigned to content sources.

Graphics engine 144 may be utilized for the rendering of one or more objects, e.g., 3D objects associated with the virtual environment. Classification controller 146 may be utilized to classify assets such as 3D objects and for the detection of inauthentic digital assets, etc. Data store 148 may be utilized to store a search index, model information, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience (e.g., a game) 106 may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or user devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character, e.g., dimensions (height, width, girth, etc.); shape; movement style; number/type of parts; proportion, etc.

In some implementations, the 3D model may include a 3D mesh. The 3D mesh may define a three-dimensional structure of an unauthenticated virtual 3D object. In some implementations, the 3D mesh may also define one or more surfaces of the 3D object. In some implementations, the 3D object may be a virtual avatar, e.g., a virtual character such as a humanoid character, an animal-character, a robot-character, etc.

In some implementations, the mesh may be received (imported) in a FBX file format. The mesh file includes data that provides dimensional data about polygons that comprise the virtual 3D object and UV map data that describes how to attach portions of texture to various polygons that comprise the 3D object. In some implementations, the 3D object may correspond to an accessory, e.g., a hat, a weapon, a piece of clothing, etc. worn by a virtual avatar or otherwise depicted with reference to a virtual avatar.

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences, e.g., games. The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience, e.g., a game developer or any other person who seeks to create a virtual experience that may be published by an online virtual experience platform and utilized by others. The user interface of the virtual experience development environment may be rendered on a display screen of a client device, e.g., such as a developer device 130 described with reference to FIG. 1, so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device. In some implementations, audio engine 116 may act cooperatively with audio engine 144 that is installed on the sound server.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs), and thus is not limited to use in websites.

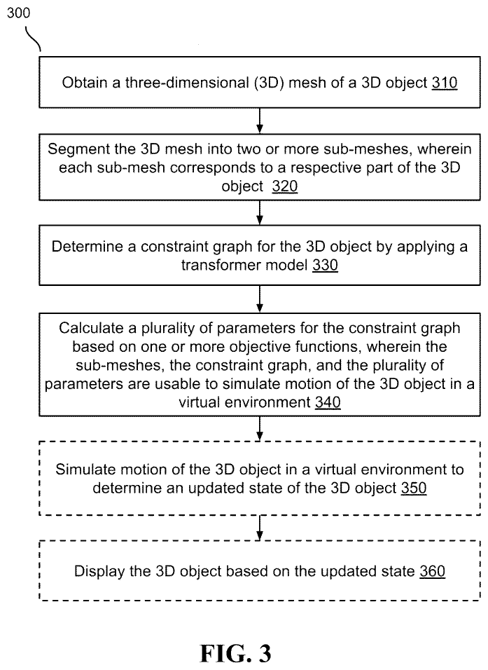

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or content management server 140 may perform one or more of the operations described below in connection with the flowcharts and workflows shown in FIG. 3.

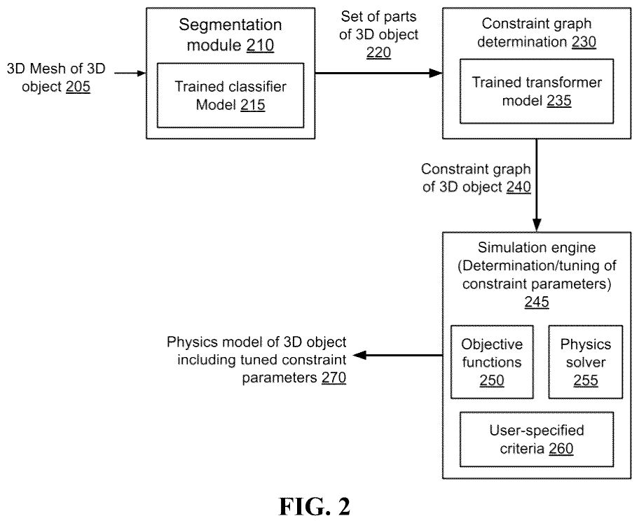

FIG. 2 depicts an example of an end-to-end workflow to perform automatic rigging of physics-based three-dimensional (3D) objects, in accordance with some implementations.

As depicted in FIG. 2, the workflow includes providing a 3D mesh of a 3D object 205 to a segmentation module 210. The segmentation module may include a trained classifier model 215 (also referred to as trained regression model 215). The segmentation module outputs a set of parts of the 3D object 220. The set of parts is provided to a constraint graph determination module 230. The constraint graph determination module 230 includes a trained transformer model 235 that generates a constraint graph.

A constraint graph 240 of the 3D object generated by constraint determination module 230 is provided to a simulation engine 245 for tuning of constraint parameters. The simulation engine may operate using objective functions 250 and user-specified criteria 260, and includes a physics solver 255. The output of simulation engine 245 is a physics model of the 3D object that includes tuned constrained parameters 270.

FIG. 3 illustrates an example method to perform automatic rigging of a three-dimensional (3D) object, in accordance with some implementations.

In some implementations, method 300 can be implemented, for example, on virtual experience 102 described with reference to FIG. 1. In some implementations, some or all portions of the method 300 can be implemented on one or more client devices 110 as shown in FIG. 1, on one or more developer devices 130, or on one or more server device(s) 102, and/or on a combination of developer device(s), server device(s), and client device(s). In described examples, the implementing system includes one or more digital processors or processing circuitry (“processors”), and one or more storage devices (e.g., a database 120 or other storage). In some implementations, different components of one or more servers and/or clients can perform different blocks or other parts of the method 300. In some examples, a first device is described as performing blocks of method 300. Some implementations can have one or more blocks of method 300 performed by one or more other devices (e.g., other client devices or server devices) that can send results or data to the first device.

In some implementations, the method 300, or portions of the method, can be initiated automatically by a system. In some implementations, the implementing system is a first device. For example, the method (or portions thereof) can be periodically performed, or performed based on one or more particular events or conditions, e.g., a request received from a user to rig a 3D object, receiving a 3D mesh of a physics-based 3D object at the virtual experience platform, a predetermined time period having expired since the last performance of method 300, and/or one or more other conditions occurring which can be specified in settings read by the method. Method 300 may begin at block 310.

At block 310, a three-dimensional (3D) mesh of a 3D object is obtained. The 3D mesh is a representation (e.g., a mathematical model) of the geometry of the 3D object. In some implementations, the 3D mesh may define one or more surfaces of the 3D object. In some implementations, the 3D object may be a physics-based 3D object, e.g., a vehicle, a mechanism, an assembly, etc. In some implementations, the 3D object may be an inanimate object, an accessory such as clothing, weapon, etc. In some other implementations, the 3D object may be an imaginary character or avatar.

In some implementations, the 3D mesh may be generated by applying a generative machine learning (gen-ML) model to a user provided prompt, e.g., a text prompt, a voice prompt, a sketch, etc., that specifies elements of a 3D object. Tools provided by the virtual experience platform may enable users to apply the gen-ML techniques to generate 3D object meshes based on provided descriptions.

In some implementations, the virtual experience platform may enable users to submit (upload) 3D meshes of the 3D objects for utilization on the platform. A virtual experience development environment (developer tool) may be provided by the platform, in accordance with some implementations. In some implementations, the 3D mesh may be received (imported) in a FBX file format. The mesh file may include data that provides dimensional data about polygons that comprise the virtual 3D object and UV map data that describes how to attach portions of texture to various polygons that comprise the 3D object. Block 310 may be followed by block 320.

At block 320, the 3D mesh is segmented into two or more sub-meshes by applying a mesh segmentation technique. A sub-mesh may correspond to a respective component (part) of the 3D object.

In some implementations, a mesh segmentation algorithm is used to identify individual components based on the surface geometry of the physics-based asset, as represented by the 3D mesh of the 3D object.

In some implementations, the mesh segmentation module may utilize a trained classifier that is trained to identify individual parts from polygonal meshes. The classifier is provided with mesh features such as curvatures or heat kernel signatures, as an input. It utilizes a heat diffusion process to enable communication between features in order to produce a more discriminative feature, and then utilized to make segmentation predictions based on the learned feature. In some implementations, parts of the 3D object and a corresponding sub-mesh associated with a part is identified by the trained classifier.

In some implementations, the mesh segmentation module may utilize a trained regression model to learn the probability of a mesh element belonging to a certain segmentation label in order to perform mesh segmentation.

In some implementations, the 3D mesh may be converted into point cloud(s) prior to the application of the mesh segmentation technique. In such implementations, the segmentation of the 3D mesh into sub-meshes is performed on the point clouds(s) generated from the 3D mesh of the 3D object.

In some implementations, user annotations may be used to enhance performance of the mesh segmentation module. For example, user provided descriptions, captions, labels, etc., may be utilized by the mesh segmentation module in segmenting the 3D mesh of the 3D object into sub-meshes.

In some implementations, in addition to segmenting the 3D mesh into a plurality of sub-meshes, the mesh segmentation module may also be utilized to generate a labeled set of parts, e.g., text descriptions of the various identified parts. In some implementations, an identified sub-mesh is assigned a respective label.

In some implementations, a category of the 3D object may be determined by performing a broad classification of the 3D object, and the category of the 3D object may be utilized to aid the mesh segmentation. For example, if it is determined that the 3D object is an airplane, the mesh segmentation module may be provided with additional inputs associated with sub-meshes of parts that are likely to be included in the 3D mesh, e.g., fuselage, rudder, wing, slats, stabilizer, engine(s), etc.

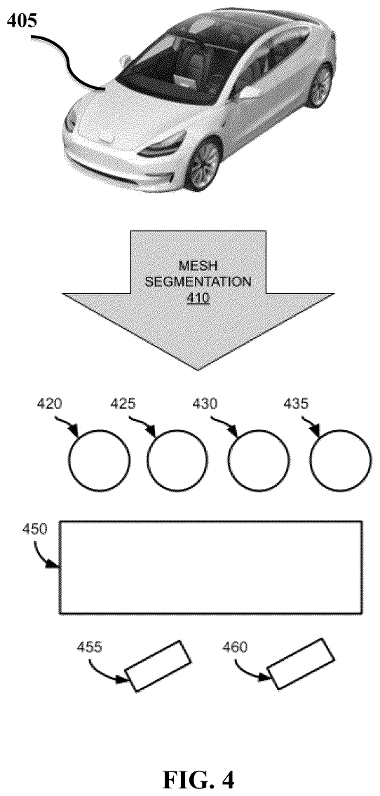

FIG. 4 illustrates an example of applying a segmentation model to a 3D object to determine sub-meshes, in accordance with some implementations.

In this illustrative example, a segmentation module, e.g., segmentation module 210 described with reference to FIG. 2, is utilized to perform mesh segmentation 410 of a 3D mesh of an example 3D object, car 405.

As depicted in FIG. 4, different parts of the car are segmented (identified). The segmented parts (and associated sub-meshes) include a left front wheel 420, a right front wheel 425, a left rear wheel 430, and a right rear wheel 435. The segmented parts additionally include a chassis 450, a left door 455, and a right door 460.

In some implementations, only the sub-meshes may be identified and segmented by segmentation module 210. In some other implementations, the sub-meshes as well as their descriptors (labels) may be determined.

In some implementations, material properties of the parts may also be inferred by the segmentation module. For example, a degree of deformability of a part, e.g., whether a wheel is made of rubber and hence more deformable than another wheel that is made of metal, may be inferred. Default values for material properties, e.g., tensile strength, break point, etc., of components may also be inferred, e.g., based on a stored database (library) that includes material properties for a variety of materials, while performing the segmentation.

In some implementations, method 300 may further include training the classifier model. In some implementations, training comprises training the classifier model on a training dataset that includes 3D meshes of 3D objects and sub-meshes corresponding to the 3D meshes.

In some implementations, a training dataset may be created that includes 3D meshes of a variety of physics-based 3D objects and their corresponding sub-meshes. In some implementations, the training dataset may optionally include labels for the sub-mesh. The training dataset may be generated by humans, or from automatically constructed 3D objects that are constructed from various combinations of known geometric primitives.

In some implementations, training of the classifier model is performed via supervised learning where a goal for the classifier is to separate a 3D mesh in the training dataset into sub-meshes that match the known ground truth sub-meshes. In some implementations, an additional training goal for the classifier is to learn to associate a label with a sub-mesh, e.g., door, chassis, wheel, etc., for a car.

In some implementations, the classifier model may be trained to associate a contiguous collection of geometric primitives with a part of the 3D object. Block 320 may be followed by block 330.

At block 330, a constraint graph for the 3D object is determined by applying a trained transformer model to the segmented sub-meshes of the 3D object. In some implementations, the constraint graph defines a set of joints such that a joint defines constraints on motion of respective pairs of identified parts of the 3D object.

In some implementations, two or more sub-meshes, e.g., the two or more sub-meshes identified at block 320, may be provided as input to the trained transformer model. Given a set of segmented (and optionally, labeled) parts of a 3D object, a set of constraints that couples the motion of pairs of parts of the 3D object is determined by using the trained transformer model.

In some implementations, determining the constraint graph for the 3D object by using the transformer model may include providing the two or more sub-meshes (parts) as a sequence of tokens to the transformer model. In some implementations, the sequence of tokens is mapped by the transformer model to the constraint graph for the 3D object. In some implementations, an identified sub-mesh (part) is mapped to an individual token, and a collection of sub-meshes (parts) that is segmented from the 3D mesh is mapped to a set of tokens that represents the 3D mesh. The set of tokens, when provided as a sequence to the trained transformer model, is mapped by the transformer model to determine the constraint graph for the 3D object.

In some implementations, tokens corresponding to a sub-mesh may be determined by a pre-trained transformer. For each sub-mesh, a set of points (e.g., 1024 points) may be sampled uniformly on the surface of the sub-mesh of a component (part), and then passed to the transformer, which generates token(s) corresponding to the points.

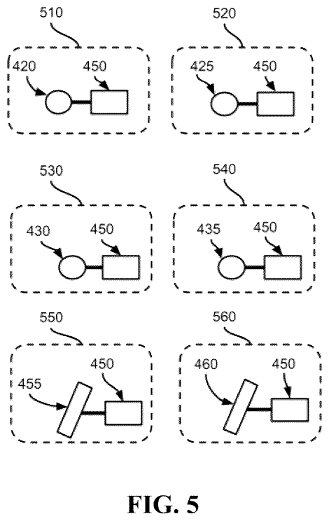

FIG. 5 illustrates an example of a constraint graph determined for a 3D object based on a set of sub-meshes, in accordance with some implementations.

FIG. 5 depicts a constraint graph determined by a trained transformer model based on a sequence of sub-meshes associated with a 3D object. In this illustrative example, the sequence of sub-meshes is the set of sub-meshes (420, 425, 430, 440, 450, 455, and 460) described with reference to FIG. 4. This example sequence of sub-meshes includes sub-meshes associated with parts identified from a 3D mesh of a car.

In some implementations, an objective of applying a trained transformer model is to infer the constraint graph that includes determining joint type(s), e.g., springs, hinges, cylindrical joints, etc.

In some implementations, the constraint graph includes a set of constraints that pose restrictions (e.g., limit degrees of freedom) on the motion of constituent components (e.g., rigid body components) of a 3D object. Examples of constraints include joints (such as ball joints, hinge joints), etc., and non-penetration constraints.

As an example, a cylindrical joint refers to a joint that constrains two bodies to a single axis while allowing the two bodies to rotate about and slide along that axis. For example, a cylindrical constraint (cylindrical joint) may be utilized to represent an unsecured axle mounted on a chassis of a vehicle since the axle may freely rotate and translate about an axis.

As another example, a spring joint may be utilized to join two rigid body objects (components) together but enables the distance between them to change as though they were connected by a spring. For example, a spring joint may be utilized to represent suspension springs that connect a wheel (or a set of wheels) to a chassis of a vehicle, and which enables up/down motion of the chassis relative to the wheels.

Accordingly, in this illustrative example, the constraint graph includes a first cylindrical joint 510 that couples wheel 420 with chassis 450, a second cylindrical joint 520 that couples wheel 425 with chassis 450, a third cylindrical joint 530 that couples wheel 430 with chassis 450, and a fourth cylindrical joint 540 that couples wheel 435 with chassis 450.

The constraint graph additionally includes a first hinge joint 550 that couples left door 455 and chassis 450, and a second hinge joint 560 that couples right door 460 and chassis 450.

In some implementations, method 300 may further include training the transformer model with a training dataset. In some implementations, the training of the transformer model may be performed by utilizing a training dataset that includes segmented 3D models that include a plurality of sub-meshes of the 3D object and corresponding physics models that include a constraint graph determined for the 3D object. In some implementations, the training dataset may be created based on 3D models available on the virtual experience platform, e.g., models that have been previously created and uploaded to the platform,

In some implementations, method 300 may further include training the transformer model with an augmented training dataset, wherein the augmented training dataset includes random sequences of segmented labeled parts of 3D meshes of parts of 3D objects included in the training dataset. In some implementations, training the transformer model with the augmented training dataset enables the model to learn a broader ordering of parts rather than learn a default ordering.

Block 330 may be followed by block 340.

At block 340, a plurality of parameters for the constraint graph is calculated based on one or more objective functions. In some implementations, determining the plurality of parameters may include determining values for one or more parameters associated with a constraint or joint. For example, the plurality of parameters may include determining a relative position and orientation of each component in a pair of components that are connected by a constraint (joint).

In some implementations, determining the plurality of parameters includes refining specific parameters of the physics asset in order to achieve specific behaviors based on the determined parts and constraint graph.

In some implementations, the plurality of parameters may include material or other physical properties of the components and/or the constraints. For example, a spring constant of a spring joint that is utilized to represent a suspension may be determined. As another example, a value for a coefficient of rolling friction for a wheel of a vehicle may be determined.

In some implementations, determining the plurality of parameters may be based on user-specified criteria, e.g., wobbliness of truck, driving smoothness of car, etc. The user-specified criteria may be translated into specific components and/or joints identified during the segmentation process. In some implementations, determining the plurality of parameters for the constraint graph may include determining values for the one or more parameters associated with the set of joints based on user-specified criteria.

In some implementations, determining the values for the one or more parameters associated with the set of joints may include performing an optimization of one or more objective functions that are utilized to encode the user-specified criteria. In some implementations, the optimization may be a gradient-based optimization targeted at meeting the user-specified criteria.

In some implementations, determining values for the one or more parameters for the constraint graph may include first determining a type of the one or parameters based on the user-specified criteria. In some implementations, user-specified criteria may be received from a user, which may then be mapped to one or more parameters for the constraint graph. Values for the one or more parameters may then be determined via optimization, as described earlier.

For example, a user may indicate or specify “smooth ride” as a criterion for a 3D object that is a vehicle. In some implementations, it may first be determined that a spring coefficient for a joint is the parameter to be optimized to achieve the “smooth ride” criterion. Values for the spring coefficient may then be determined that enables the vehicle to meet the user-specified criteria.

In some implementations, user provided objective functions may be utilized to determine the plurality of parameters by applying numerical techniques and/or machine learning (ML) techniques. In some implementations, a series of objective functions defined by a user may be utilized to optimize a set of parameters.

For example, given a set of parameters, an objective function, L(θ) may be optimized (e.g., minimized or maximized), and represented as:

$${min}_{θ} ‖ L ( θ ) ‖$$

In some implementations, the objective function(s) encode the optimality of specific behaviors. For example, in the case of a 3D object that is a vehicle, the function L may encode how well the vehicle drives forward in a straight line (“smooth ride”), the turning radius, its ability to accelerate quickly, or drift around corners, and may include parameters such as joint positions and orientations, coefficients of friction, compliance and damping, maximum torque and forces, etc.

In some implementations, a numerical technique or machine learning technique is utilized to optimize L(θ). Formally, given a set of parameters, the numerical optimizer attempts to minimize (maximize) objective function L(θ), and the optimal values for the set of parameters determined by the optimization is utilized in the physics model.

In some implementations, a simulation of the 3D object under standard test conditions may be performed, e.g., by utilizing a physics engine, to determine its behavior, e.g., bounciness of ride, braking efficiency, roll characteristics, etc. Multiple iterations may be performed, and the parameters of the constraint graph may be adjusted after every iteration until a specified behavior is achieved.

In some implementations, a default set of values for the plurality of parameters may be determined by the segmentation model, which may further be tuned via optimization based on user provided criteria.

In some implementations, labels for components, e.g., labels determined during the segmentation of the 3D mesh, labels provided by the users, etc., may be utilized to determine values for the plurality of parameters. In some implementations, a predefined set of 3D object behavior may be obtained and stored in a library associated with the virtual experience platform. For example, if a part (component) is labeled as a wheel, predefined behaviors associated with a wheel may be assigned to the component to determine the plurality of parameters for the part.

In some implementations, gradient-based optimization may be performed in conjunction with a differentiable physics engine (physics solver) to determine the optional set of values for the parameters for the constraint graph. In some implementations, when the underlying physics behavior is not differentiable, gradient-free optimization techniques, such as proximal policy optimization, may be utilized.

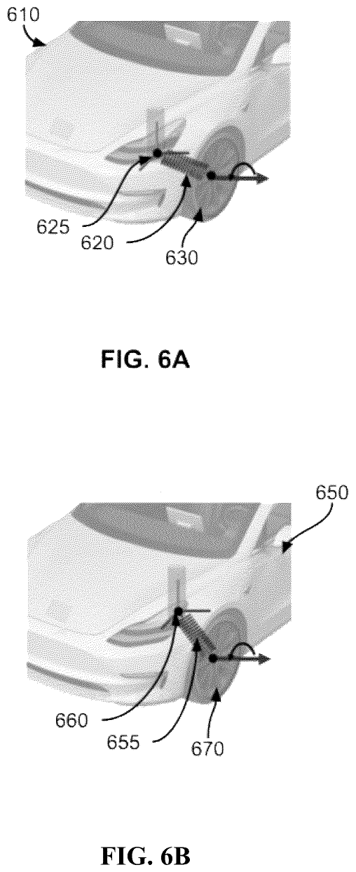

FIG. 6A depicts an example of tuning of constraint parameters for a 3D object, in accordance with some implementations.

In this illustrative example, tuning of a constraint in the constraint graph is depicted in the context of a car. At initialization of the tuning, e.g., upon completion of the stages of segmentation and constraint graph determination as described with reference to blocks 320 and 330, respectively, car 610 includes wheel 630 that is coupled to chassis 625 by a spring joint 620.

FIG. 6B depicts an example of a 3D object with optimized constraint graph parameters, in accordance with some implementations.

FIG. 6B depicts car 650 subsequent to tuning/optimization of constraint graph parameters. As depicted in FIG. 6, car 650 after the tuning depicts wheel 670 coupled via spring joint 655 at a different position in the chassis 660 when compared to the state at initialization (FIG. 6A). In some scenarios, the spring constant of spring joint 655 may also be adjusted (not shown) to meet user-specified criteria, e.g., a smooth ride.

In some implementations, tuning may include performing a set of simulations using a physics solver (physics engine), starting with an initial state, and adjusting one or more parameters until the objective function that encodes user-specified criteria is optimized.

The combination of the sub-meshes, the constraint graph, and the plurality of parameters constitute a physics model of the 3D object that is usable to simulate motion of the 3D object in a virtual environment.

Block 340 may be followed by block 350.

At block 350, motion of the 3D object in a virtual environment may be simulated by providing to a physics solver a current or input state of the 3D object, the constraint graph, the plurality of parameters, and one or more forces acting on the 3D object to determine an updated state of the 3D object.

The state of the 3D object may either be an initial state, e.g., at the start/commencement of a simulation, or a previous 3D object state from a previously determined state. For example, an input state may be an initial state of a vehicle in a virtual environment, just before the vehicle starts moving.

Inputs to the physics solver may include external force(s) that act on the 3D object within the virtual environment, e.g., a gravitational force that is acting on a falling object. The external force(s) may be a default setting within the environment, user defined settings, or a combination. For example, a specified horsepower of a vehicle and an input setting provided by a user (e.g., using a gamestick or remote) may be utilized to derive a force acting on a vehicle based on generated engine power. Similarly, a user may specify a gravity-free setting for a virtual environment, which results in simulation of a gravity-free virtual environment, e.g., gravitational forces would not be applied on the 3D object.

Based on provided inputs, the physics solver determines an updated state, e.g., position, orientation, velocity, etc., of the 3D object by solving for the motion of the 3D object as represented by the physics model (the segmented sub-meshes and/or representative rigid body parts, the constraint graph and the determined parameters for the constraint graph) under the influence of various provided inputs. Block 350 may be followed by block 360.

At block 360, the 3D object may be displayed, e.g., on a display screen, based on the determined updated state. The updated velocity, orientation, and/or position of the 3D object may be utilized for animation and determining images (frames) of the virtual environment that depict a state and motion of the 3D object in the virtual environment.

Method 300, or portions thereof, may be repeated any number of times using additional inputs. Blocks 310-360 may be performed (or repeated) in a different order than described above and/or one or more steps can be omitted. For example, blocks 350-360 may be omitted in some implementations. Blocks 310-360 may be performed at different rates. For example, blocks 310-340 may be performed once when a 3D object mesh is received and blocks 350-360 may be performed multiple times based on a physics model generated at block 340. Additionally, blocks 310-340 may be repeated if it is determined that the 3D object has undergone changes in the virtual environment that may necessitate one or more sub-meshes and/or constraint graph parameters to be determined afresh.

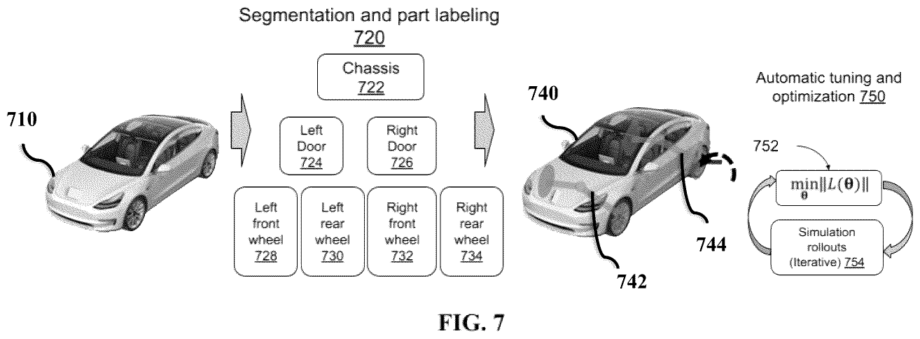

FIG. 7 illustrates an end-to-end workflow to perform automatic rigging of physics-based three-dimensional (3D) objects, in accordance with some implementations.

In some implementations, the workflow commences with obtaining a 3D mesh of a 3D object 710. In this illustrative example, the 3D object 710 is a car. Segmentation and part labeling 720 is performed based on the 3D mesh, which yields a set of sub-meshes (parts).

As depicted in FIG. 7, the sub-meshes include meshes associated with chassis 722, left door 724, right door 726, left front wheel 728, left rear wheel 730, right front wheel 732, and right rear wheel 734.

The sub-meshes are provided as a sequence of tokens to a trained transformer model to determine a constraint graph. As depicted pictorially in FIG. 7, 3D object 740 includes an identification of a set of constraints based on the sequence of sub-meshes. Example constraints such as a first cylindrical joint 742 and a second cylindrical joint 744 are depicted in FIG. 7.

Automatic tuning and optimization 750 is performed based on the constraint graph. A set of objective functions, L(θ), defined based on user-specified criteria, is optimized using a set of simulation rollouts 754 to determine values for a set of parameters associated with the constraint graph for the 3D object.

A physics model for the 3D object that includes the sub-meshes, the constraint graph, and the set of tuned parameters for the constraint graph may be utilized in a virtual experience by applying a physics engine (physics solver) to simulate motion of the 3D object.

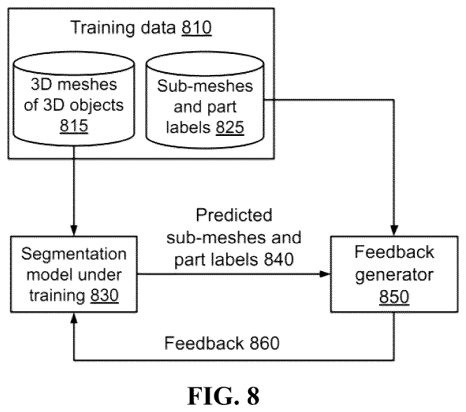

FIG. 8 depicts an example training of a classifier model to determine one or more sub-meshes from a mesh of a 3D object, in accordance with some implementations.

The training can be implemented on a computer that includes one or more processors and memory with software instructions. In some implementations, the one or more processors may include one or more of a general-purpose central processing unit (CPU), a graphics processing unit (GPU), a machine-learning processor, an application-specific integrated circuit (ASIC), a field-programmable gate array (FPGA), or any other type of processor.

In this illustrative example, a segmentation model 830 is trained based on training data 810 and a feedback generator 850. The segmentation model 830 may be any type of suitable machine learning model, e.g., a classifier neural network with a plurality of layers, each layer comprising a plurality of neurons, and respective weights for each neuron.

Training data 810 includes a plurality of 3D meshes of 3D objects 815 and associated ground truth sub-meshes and labels 825. The 3D meshes may include meshes of 3D objects both from within a virtual experience platform (e.g., previously submitted and segmented 3D meshes) and from outside the virtual experience platform, e.g., publicly available (and licensed/permitted for use for ML training purposes) segmented sub-meshes of 3D meshes of 3D objects. The ground truth labels may be obtained from tags provided by the developers of the meshes and/or from other automated label generators. In some implementations, the ground truth labels may be obtained by manual review of the 3D object meshes.

In this illustrative example, 3D meshes of 3D objects 815 are provided to a segmentation model under training 830. The segmentation model generates predicted sub-meshes and part labels 840 based on a current state of the segmentation model (segmentation model parameters, including weights) and the received 3D meshes of 3D objects. The sub-meshes and part labels 840 are provided to feedback generator 850.

Feedback generator 850 is also provided with the ground truth sub-meshes and labels 825 corresponding to each 3D mesh utilized in training. Feedback 860 is generated by feedback generator 850 based on a comparison of the predicted sub-meshes and part labels with the ground truth sub-meshes and labels 825. For example, gradient descent or other techniques may be utilized to generate feedback (weight adjustments) for the segmentation model 830. The feedback 860 is utilized to update the weights of the segmentation model 830. The segmentation model may be implemented using any of multiple techniques that can perform segmentation and/or classification of 3D meshes into sub-meshes.

Training may be performed in epochs, with each epoch using a subject of the 3D meshes and ground truth sub-meshes for training segmentation model 830. In each epoch, weights and/or other parameters of the segmentation model are adjusted based on the feedback 860 in a manner that increases a likelihood that a predicted set of sub-meshes (and optionally labels) for a 3D mesh matches a corresponding ground truth set of sub-meshes (and optionally labels) for individual 3D meshes of 3D objects.

The trained segmentation model 830 can be used as trained regression model 215 of segmentation module 210, described with reference to FIG. 2.

The training of the segmentation model may be performed periodically at specified intervals, or be triggered by specific events. In some implementations, the training may be performed until a threshold level of segmentation accuracy is reached, all of the training data is utilized, a computational budget for training is exhausted, an improvement in segmentation accuracy between consecutive training epochs falls below a threshold, or other criteria.

The training dataset may include a large dataset of 3D meshes of 3D objects and corresponding segmented versions of the 3D meshes into constituent parts (sub-meshes). Effectiveness of the technique may be improved by including a large dataset that includes physics-based mechanisms. In some implementations, a label associated with the parts may also be included in the training dataset. type (labels). Again, using vehicle rigging as an example, a contiguous collection of geometric primitives (e.g., polygons and 3D points) may represent a single part.

Part labels may be domain specific. For example, for vehicles, labels that refer to externally viewable parts of the vehicle such as door, wheel, etc., are utilized. In some implementations, a broader classification may also be learned if a sufficiently high-quality dataset is available.

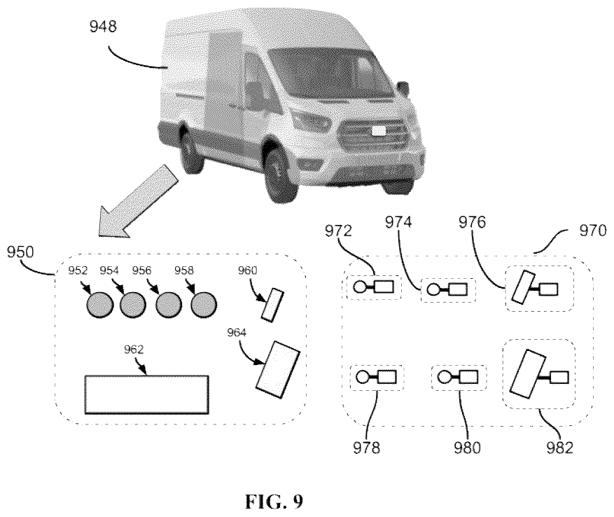

FIG. 9 depicts an example sequence of sub-meshes and a corresponding target constraint graph utilized in training a transformer model, in accordance with some implementations.

In this illustrative example, segmentation of a 3D mesh is performed, e.g., of an example 3D object 948 to determine a set of sub-meshes 950 that is provided as an input sequence.

As depicted in FIG. 9, the input sequence 950 includes a first wheel 952, a second wheel 954, a third wheel 956, and a fourth wheel 958. The input sequence 950 additionally includes chassis 962, a hinged door 960, and a sliding door 964.

The target constraint graph 970 is a set of constraints for the 3D object 948 that includes a first cylindrical joint 972, a second cylindrical joint 974, a third cylindrical joint 978, a fourth cylindrical joint 980, a hinge joint 980 (for the hinged door), and a prismatic joint 982 (for the sliding door).

Training of the transformer model is based on multiple sequences of sub-meshes and corresponding constraint graphs; the training may be repeated until a threshold accuracy is achieved by the transformer model. The trained transformer model can be utilized to determine a constraint graph, e.g., as trained transformer model 235 within constraint graph determination module 230.

The training dataset includes sets of labeled sub-meshes (parts) and corresponding constraint graphs of physics-based 3D objects. Each element in the training dataset includes, for each 3D object, a set of parts (sub-meshes) and a set of constraints and parts (rigid bodies) coupled by each of the constraints.

Additionally, data augmentation may be used to generate random sequences of segmented labeled parts so that the transformer model does not learn a specific or default ordering of the parts. For instance, in some implementations, random rotations and scaling may be applied to the object. The physical joints (e.g., rotating the wheels of a car) may also be adjusted to different positions and/or orientations in order to create additional variants from each training data.

In some implementations, spatial data, e.g., a center of mass/geometry, may also be included as training inputs to improve performance of the transformer model. For instance, the entire mesh may be spatially transformed such that the mesh is centered at the center of mass prior to being provided to the transformer model. This may enable factoring out the influence of any spatial translations.

The trained transformer model can subsequently be utilized to map received sets of sub-meshes to determine a corresponding constraint-part graph.

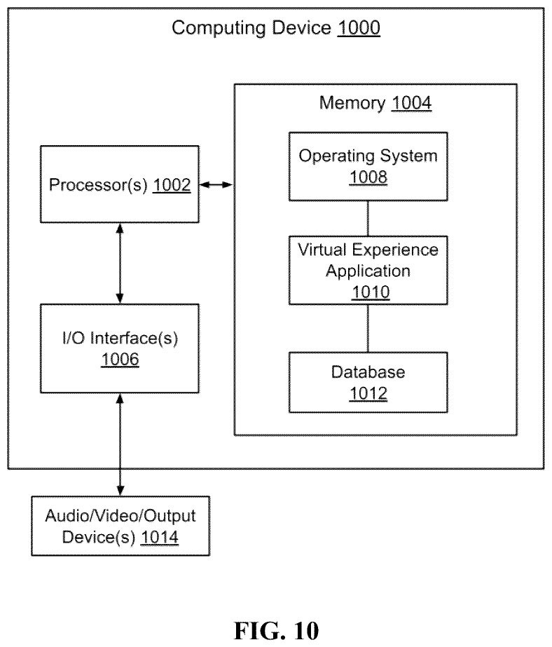

FIG. 10 illustrates an example computing device, in accordance with some implementations.

In one example, device 1000 may be used to implement a computer device (e.g., 102, 110, and/or 130 of FIG. 1), and perform suitable method implementations described herein. Computing device 1000 can be any suitable computer system, server, or other electronic or hardware device. For example, the computing device 1000 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 1000 includes a processor 1002, a memory 1004, input/output (I/O) interface 1006, and audio/video input/output devices 1014.

Processor 1002 can be one or more processors, processing devices, and/or processing circuits to execute program code and control basic operations of the device 1000. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1004 is typically provided in device 1000 for access by the processor 1002, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1002 and/or integrated therewith. Memory 1004 can store software operating on the server device 1000 by the processor 1002, including an operating system 1008, one or more applications 1010, e.g., an audio spatialization application, a sound application, content management application, and application data 1012. In some implementations, application 1010 can include instructions that enable processor 1002 to perform the functions (or control the functions of) described herein, e.g., some or all of the methods described with respect to FIG. 3.

For example, applications 1010 can include an audio spatialization module which as described herein can provide audio spatialization within an online virtual experience server (e.g., 102). Any software in memory 1004 can alternatively be stored on any other suitable storage location or computer-readable medium. In addition, memory 1004 (and/or other connected storage device(s)) can store instructions and data used in the features described herein. Memory 1004 and any other type of storage (magnetic disk, optical disk, magnetic tape, or other tangible media) can be considered “storage” or “storage devices.”

I/O interface 1006 can provide functions to enable interfacing the server device 1000 with other systems and devices. For example, network communication devices, storage devices (e.g., memory and/or data store 120), and input/output devices can communicate via interface 1006. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1014 can include a user input device (e.g., a mouse, etc.) that can be used to receive user input, a display device (e.g., screen, monitor, etc.) and/or a combined input and display device, that can be used to provide graphical and/or visual output.

For case of illustration, FIG. 10 shows one block that is representative of each processor 1002, memory 1004, I/O interface 1006, and software blocks 1008 and 1010. These blocks may represent one or more processors, computing instances on distributed computing systems, processing devices, or processing circuitries, operating systems, memories, I/O interfaces, applications, and/or software engines. In other implementations, device 1000 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the device 1000, e.g., processor(s) 1002, memory 1004, and I/O interface 1006. An operating system, software and applications suitable for the user device can be provided in memory and used by the processor. The I/O interface for a user device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1014, for example, can be connected to (or included in) the device 1000 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 300, etc.) can be implemented by computer program instructions or code, which can be executed on a computer. For example, the code can be implemented by one or more digital processors (e.g., microprocessors or other processing circuitry), and can be stored on a computer program product including a non-transitory computer-readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a user device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may be executed on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
obtaining a three-dimensional (3D) mesh of a 3D object;
segmenting the 3D mesh into two or more sub-meshes, wherein each sub-mesh corresponds to a respective part of the 3D object;
determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object; and
calculating a plurality of parameters for the constraint graph based on one or more objective functions, wherein the sub-meshes, the constraint graph, and the plurality of parameters are usable to simulate motion of the 3D object in a virtual environment.

2. The computer-implemented method of claim 1, wherein determining the constraint graph for the 3D object using the transformer model comprises providing the two or more sub-meshes as a sequence of tokens to the transformer model, wherein the sequence of tokens is mapped by the transformer model to the constraint graph for the 3D object.

3. The computer-implemented method of claim 1, wherein calculating the plurality of parameters for the constraint graph comprises determining values for one or more parameters associated with the set of joints based on user-specified criteria.

4. The computer-implemented method of claim 3, wherein determining the values for the one or more parameters associated with the set of joints comprises performing an optimization of the one or more objective functions that encode the user-specified criteria.

5. The computer-implemented method of claim 3, further comprising:
receiving the user-specified criteria from a user; and
determining a respective type of the one or parameters based on the user-specified criteria.

6. The computer-implemented method of claim 1, wherein segmenting the 3D mesh into the two or more sub-meshes comprises applying a trained classifier to the 3D mesh of the 3D object.

7. The computer-implemented method of claim 6, further comprising training the classifier, wherein the training comprises training the classifier on a training dataset that includes 3D meshes of 3D objects and sub-meshes corresponding to the 3D meshes.

8. The computer-implemented method of claim 1, further comprising training the transformer model with an augmented training dataset, wherein the augmented training dataset includes sequences of segmented labeled parts of 3D meshes of parts of 3D objects included in the training dataset.

9. The computer-implemented method of claim 1, wherein segmenting the 3D mesh into the two or more sub-meshes comprises applying a trained regression model to the 3D mesh of the 3D object.

10. The computer-implemented method of claim 1, further comprising:
simulating motion of the 3D object in the virtual environment by providing to a physics solver a current state of the 3D object, the constraint graph, the plurality of parameters, and one or more forces acting on the 3D object in the virtual environment, wherein the physics solver determines an updated state of the 3D object; and
displaying the 3D object in the virtual environment based on the updated state.

11. A non-transitory computer-readable medium with instructions stored thereon that, responsive to execution by a processing device, cause the processing device to perform operations comprising:
obtaining a three-dimensional (3D) mesh of a 3D object;
segmenting the 3D mesh into two or more sub-meshes, wherein each sub-mesh corresponds to a respective part of the 3D object;
determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object; and
calculating a plurality of parameters for the constraint graph based on one or more objective functions, wherein the sub-meshes, the constraint graph, and the plurality of parameters are usable to simulate motion of the 3D object in a virtual environment.

12. The non-transitory computer-readable medium of claim 11, wherein determining the constraint graph for the 3D object using the transformer model comprises providing the two or more sub-meshes as a sequence of tokens to the transformer model, and wherein the sequence of tokens is mapped by the transformer model to the constraint graph for the 3D object.

13. The non-transitory computer-readable medium of claim 11, wherein calculating the plurality of parameters for the constraint graph comprises determining values for one or more parameters associated with the set of joints based on user-specified criteria.

14. The non-transitory computer-readable medium of claim 13, wherein determining the values for the one or more parameters associated with the set of joints comprises performing an optimization of the one or more objective functions that are utilized to encode the user-specified criteria.

15. The non-transitory computer-readable medium of claim 13, wherein the operations further comprise:
receiving the user-specified criteria from a user; and
determining a respective type of the one or parameters based on the user-specified criteria.

16. The non-transitory computer-readable medium of claim 11, wherein the operations further comprise:
simulating motion of the 3D object in a virtual environment by providing to a physics solver a current state of the 3D object, the constraint graph, the plurality of parameters, and one or more forces acting on the 3D object to determine an updated state of the 3D object; and
displaying the 3D object based on the updated state.

17. A system comprising:
a memory with instructions stored thereon; and
a processing device, coupled to the memory, the processing device configured to access the memory and execute the instructions, wherein the instructions cause the processing device to perform operations comprising:
obtaining a three-dimensional (3D) mesh of a 3D object;
segmenting the 3D mesh into two or more sub-meshes, wherein each sub-mesh corresponds to a respective part of the 3D object;
determining a constraint graph for the 3D object using a transformer model, wherein the two or more sub-meshes are provided as input to the transformer model, and wherein the constraint graph defines a set of joints such that each joint defines constraints on motion of respective pairs of the parts of the 3D object; and
calculating a plurality of parameters for the constraint graph based on one or more objective functions, wherein the sub-meshes, the constraint graph, and the plurality of parameters are usable to simulate motion of the 3D object in a virtual environment.

18. The system of claim 17, wherein segmenting the 3D mesh into the two or more sub-meshes comprises applying a trained classifier model to the 3D mesh of the 3D object.

19. The system of claim 17, wherein the operations further comprise training the transformer model with an augmented training dataset, wherein the augmented training dataset includes sequences of segmented labeled parts of 3D meshes of parts of 3D objects included in the training dataset.

20. The system of claim 17, wherein the operations further comprise:
simulating motion of the 3D object in a virtual environment by providing to a physics solver a current state of the 3D object, the constraint graph, the plurality of parameters, and one or more forces acting on the 3D object to determine an updated state of the 3D object; and
displaying the 3D object based on the updated state.
